(19) United States
(12) Patent Application Publication
(10) Pub. No.: US 2023/0013616 A1
(43) Pub. Date: Jan. 19, 2023

(54) Holder For Dental Instruments

(71) Applicant: Pacific Pearl Dental Hygiene Clinic Inc., Nanaimo (CA)

(72) Inventor: Ricki Jo WEISSBACH, Nanaimo (CA)

(73) Assignee: Pacific Pearl Dental Hygiene Clinic Inc., Nanaimo (CA)

(21) Appl. No.: 17/577,486

(22) Filed: Jan. 18, 2022

(30) Foreign Application Priority Data
Jul. 13, 2021 (CA) 3124380

(51) Int. Cl. A61C 19/00

(52) U.S. Cl. CPC A61C 19/006

(57) ABSTRACT

A holder for dental hygiene instruments is disclosed. The holder is removably attachable to the forearm of a dental hygienist to facilitate access to dental instruments while cleaning teeth. The holder includes a main body having an attachment piece affixed thereto for removable attachment of an instrument tray having the instruments removably attached thereto.

### CROSS REFERENCE TO RELATED APPLICATION

The present application claims priority to Canadian Patent Application No. 3124380 filed Jul. 13, 2021.

### FIELD

The present invention relates generally to the field of dental hygiene, and in particular to a holder for dental hygiene instruments that is attachable to the forearm of a dental hygienist to facilitate access to dental instruments while cleaning teeth.

### BACKGROUND

A wide assortment of dental hygiene instruments are used to clean teeth. Generally, between two and four dental instruments are used for a basic cleaning procedure. The instruments are either placed directly on a lined tray or positioned in a dental hygiene instrument cassette located on the tray. Throughout the cleaning procedure a dental hygienist will change out instruments dozens of times to complete the cleaning of each area of the mouth. Each time an instrument is changed the hygienist must reach-turn-lean to the tray holding the instruments to make the exchange. This constant movement causes back, neck and hand fatigue and pain, and wastes valuable time.

To reduce the ergonomic issues caused by constantly reaching for dental hygiene instruments mobile trays were developed. The trays that hold dental hygiene instruments are either placed on trolleys that are rolled around the floor or attached to a swing arm fixed to a post or the base of a chair on one side of the patient for easier access. Locating the instruments on such mobile trays still requires the hygienist to reach-turn-lean to the tray and then move-push-pull the tray into a new position. This still wastes time and causes fatigue and pain due to the constant reaching, turning and leaning.

Tool holders attachable to a person's forearm are known in other fields. For example, U.S. Pat. No. 5,056,661, issued on Oct. 5, 1991, discloses a TOOL CADDY for holding hand tools and hand tool accessories. The patent discloses a base for attaching the tools that can be detachably mounted to a person's wrist, belt or to a tool so that the tools and accessories are made readily available.

U.S. Application No. 2005/0082323, published on Apr. 21, 2005, also discloses a tool holder that can be attached to a person's forearm or wrist. The tool holder includes an armband that fastens to a person's arm and a number of tool bands or attachment points for attaching the tools. The attachment points may include magnets to assist in holding the tools.

None of these devices address the particular requirements of the dental industry that dental instruments be conveniently located for easy access by the dental professional while working, easily removed and reattached to the holder, and that the instruments be easily switched out for a completely new set of instruments for each patient.

Therefore, there is a need for a holder for dental instruments that addresses the shortcomings of the prior art.

### SUMMARY

The holder for dental instruments disclosed herein includes a main body for attachment to the wrist or forearm of the dental professional. The main body comprises a lower cuff hingably connected to an upper cuff. The inside surfaces of the upper and lower cuffs are contoured so that they fit closely around the wrist or forearm of a user. The hinge includes a spring to bias the upper and lower cuffs together with sufficient force to hold the main body securely in place on the wrist or forearm of a user. The upper cuff includes an attachment piece for removably attaching an instrument tray configured to securely and releasably hold dental instruments. The tray can be quickly attached and removed from the main body so that a new set of clean instruments can be located on the holder for use in a new procedure or for a new patient.

In accordance with one aspect then, there is provided a holder for a dental instrument tray, the holder comprising: a main body removably attachable to a user's forearm, and an attachment piece affixed to the main body for removable attachment of the instrument tray.

In one embodiment, the main body may include a lower cuff and an upper cuff. The lower cuff and the upper cuff may be hingably attached with a spring hinge, the spring hinge creating a force sufficient to bias the lower cuff and the upper cuff together around the user's forearm. The attachment tray may include a connection piece for removable attachment to the attachment piece on the main body. The attachment piece may include a pair of indents, the indents being configured and positioned to engage with a pair of outdents on the connection piece such that when the outdents are engaged with the indents, the dental instrument tray is removably attached to the main body by a click fit.

The connection piece on the instrument tray may include a curved brim on an underside of the tray, the outdents being located on opposing ends of an inside surface of the curved brim. The attachment piece is curved to match the curvature of the brim such that when inside surface of the brim is engaged horizontally with the attachment piece the outdents on the brim engage with the indents on the attachment piece. The dental instrument tray may include a stop protruding from the underside of the tray, the stop positioned opposite the brim and located to allow the attachment piece to fit between the brim and the stop to prevent accidental disengagement of the outdents and the indents when the tray is attached to the main body. The dental instrument tray may include multiple spaced-apart finger-like projections extending vertically upward from a topside of the tray for holding dental instruments. The dental instruments are held removably in place between adjacent ones of the finger-like projections by a press fit connection.

In accordance with another aspect, there is provided a holder for dental instruments, the holder comprising: a main body removably attachable to a user's forearm, the main body including an attachment piece; a tray for holding the dental instruments, the try including a connecting piece for removable attachment to the attachment piece.

In one embodiment, the attachment piece may include a pair of indents, and the connecting piece includes a curved brim located on an underside of the tray. The indents are sized and positioned to be engageable with a pair of outdents located on opposing ends of an inside surface of the curved brim. The attachment piece is curved to match the curvature of the brim such that when the inside surface of the brim is engaged horizontally with the attachment piece the outdents on the brim engage with the indents on the attachment piece to provide a removable click fit attachment of the tray to the main body. The dental instrument tray includes a stop protruding from the underside of the tray, the stop positioned opposite the brim and located to allow the attachment piece to fit between the brim and the stop to prevent accidental disengagement of the outdents and the indents when the tray is removably attached to the main body.

The dental instrument tray may include multiple spaced-apart finger-like projections extending vertically upward from a topside of the tray for holding the dental instruments. The dental instruments are held removably in place between adjacent ones of the finger-like projections by a press fit connection. The main body includes a lower cuff and an upper cuff. The lower cuff and the upper cuff may be hingably attached with a spring hinge, wherein the spring hinge creates a force sufficient to bias the lower cuff and the upper cuff together around the user's forearm.

In accordance with a further aspect, there is provided a method comprising: providing a holder for dental instruments, the holder comprising a main body, the main body comprising a lower cuff hingably connected with a spring hinge to an upper cuff, the upper cuff including an attachment piece; opening the spring hinge; positioning the main body around a user's forearm; allowing the spring hinge to close thereby removably attaching the main body around the forearm of the user; providing a dental instrument tray with a connecting piece located on an underside of the tray and multiple finger-like projections extending vertically upward from a topside of the tray; removably attaching the instrument tray to the main body by engaging the connecting piece on the tray with the attachment piece on the main body; and removably attaching the dental instruments to the tray between adjacent ones of the finger-like projections by a press fit.

### BRIEF DESCRIPTION OF THE DRAWINGS

Further features of the holder for dental instruments disclosed herein will become apparent from the following written description and the accompanying figures, in which:

FIG. 1 is a top side perspective view of one embodiment of the holder for dental instruments;

FIG. 2 is a bottom perspective view of the holder shown in FIG. 1;

FIG. 3 is a top view of the holder shown in FIG. 1;

FIG. 4 is a perspective view of the holder shown in FIG. 1 having dental instruments removably attached to the removable tray;

FIG. 5 is an exploded view of the holder shown in FIG. 1 with the tray shown separated from the main body;

FIG. 6 is a top side perspective view of another embodiment of the holder for dental instruments having an extended tray to hold additional instruments;

FIG. 7 is a bottom perspective view of the instrument tray shown in FIG. 6;

FIG. 8 is a top perspective view of the holder shown in FIG. 6 having dental instruments removably attached to the removable tray;

FIG. 9 is a perspective view of the lower cuff;

FIG. 10 is a side perspective view of the upper cuff;

FIG. 11 is a top perspective view of the upper cuff;

FIG. 12 is a bottom perspective view of one embodiment of the instrument tray;

FIG. 13 is a side view of the instrument tray shown in FIG. 12; and

FIG. 14 is a top view of the instrument tray shown in FIG. 12.

### DETAILED DESCRIPTION

The drawings illustrate at least one embodiment of a holder for dental instruments 1, including a main body 20, and a removably attachable instrument tray 50 for holding dental instruments 100.

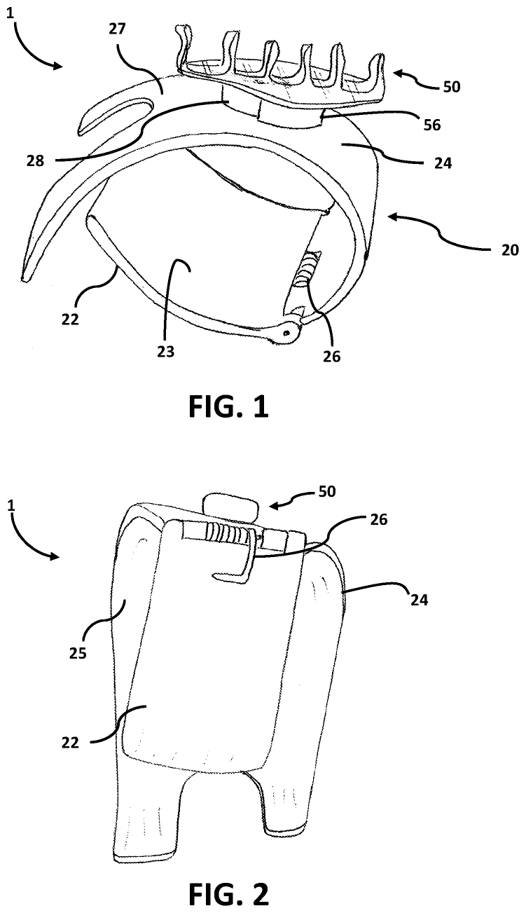

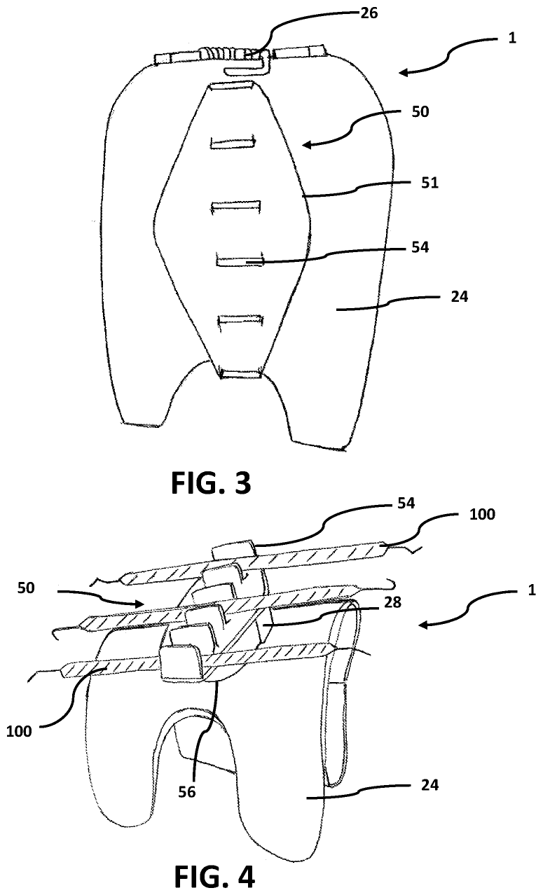

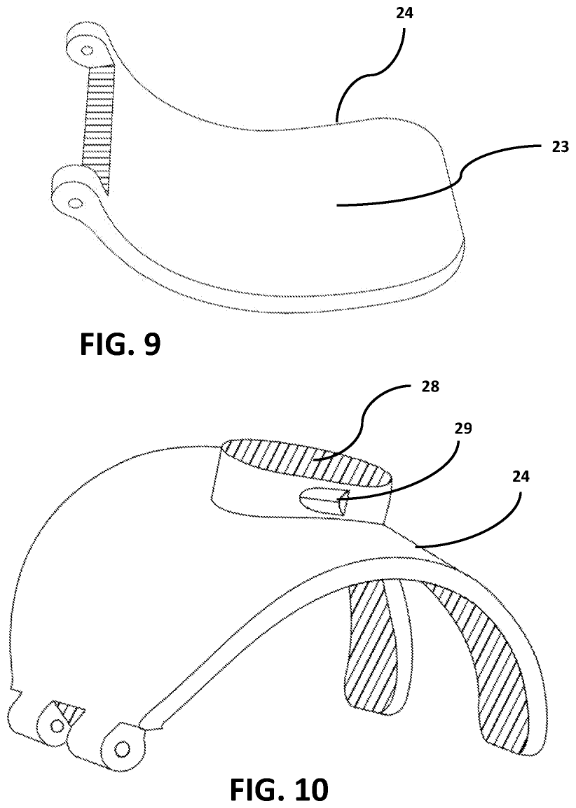

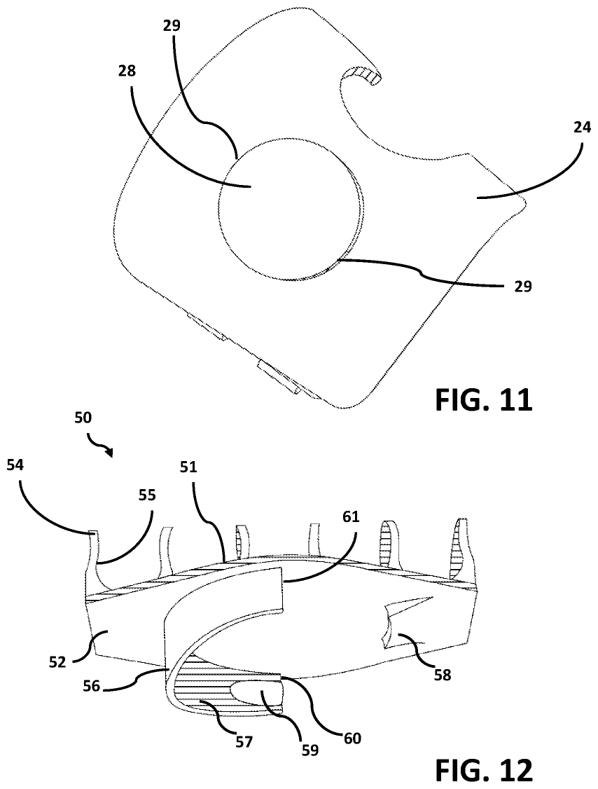

As shown in FIGS. 1 to 5, the main body 20, includes a lower cuff 22 (also shown separately in FIG. 9) configured and contoured to fit closely around a user's forearm or wrist and an upper cuff 24 (also shown separately in FIGS. 10 and 11) configured and contoured to fit closely around the user's forearm or wrist. One edge of the lower cuff 22 is hingably connected to one edge of the upper cuff 24 with a spring hinge 26. The spring hinge 26 creates sufficient force to bias the lower cuff 22 and the upper cuff 24 together around the user's forearm or wrist such that when the lower cuff 22 and the upper cuff 24 are positioned around the forearm or wrist of the user, the holder 1 remains securely in place when dental instruments are attached. The hingably connected edges of the upper cuff 24 and the lower cuff 22 are generally in parallel with the user's arm when the main body 20 is placed around the user's forearm or wrist. The inner surface 23 of the lower cuff 22 and the inner surface 25 of upper cuff 24 may be textured or lined with a material or other substance to provide some grip to assist in keeping the holder 1 secured in place on the user's forearm or wrist.

One skilled in the art will appreciate that other means may be used to attach the upper cuff 24 to the user's forearm or wrist as an alternative to the spring hinge 26 and lower cuff 22. For example, the upper cuff 24 may be fitted with straps that fasten around the user's forearm or wrist. The straps may be fastened together with a multitude of fasteners, such as buckles, snaps, or a hook and loop fastening material. In another example, the upper cuff 24 may be attached to an elastic sleeve that fits around the user's forearm or wrist to hold the upper cuff 24 securely to the user's arm.

The outer surface 27 of the upper cuff 24 includes a raised attachment piece 28 extending vertically upward from the outer surface 27. The attachment piece 28 is generally circular in shape and includes indents 29 positioned on opposite sides thereof.

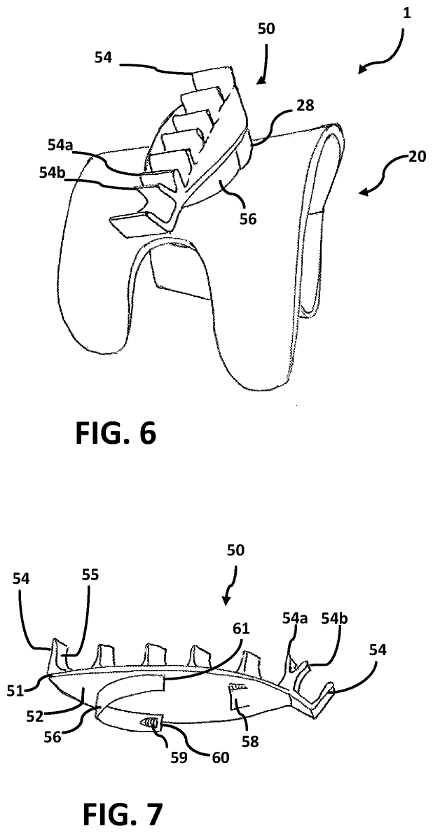

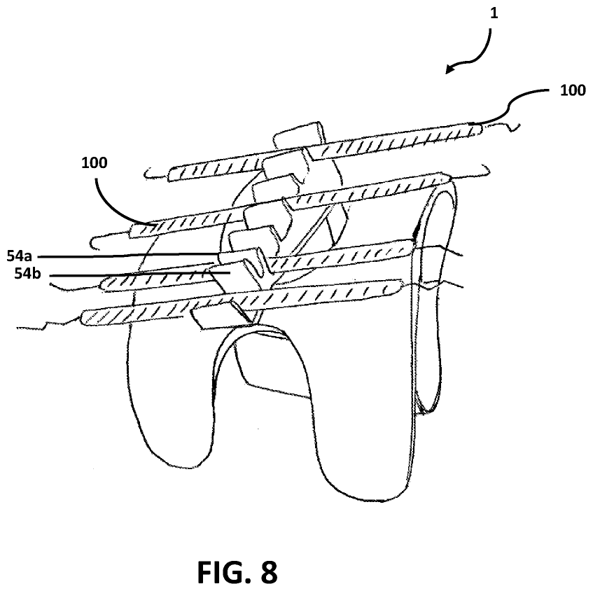

The instrument tray 50 (also shown separately in FIGS. 12 to 14) includes a base 51 having multiple spaced-apart finger-like projections 54 extending vertically upward from the base 51. The projections 54 extend approximately 1.5 cm upward from the base 51 and are spaced apart sufficiently to be able to accept and removably hold dental instruments 100 by an interference or press fit. The projections 54 may be curved on the inside surface 55 sufficient to match the contour of the dental instruments 100 and to produce a sufficient interference or press fit to hold the instrument 100 securely in place on the tray 50. The spacing between the projections 54 may be varied to accept and removably hold different sized instruments 100. FIGS. 1, 3, 4, 5, 12, 13 and 14 show the instrument tray 50 with six projections 54 to hold up to three instruments 100 as shown in FIG. 4. FIGS. 6, 7 and 8 show the instrument tray 50 with six projections 54 and two combined projections 54a, 54b for holding up to four instruments 100. The projections 54a, 54b are combined at their base to allow for instruments 100 to be located on either side of the combined projections 54a, 54b as shown in FIG. 8. This configuration allows for the base 51 to be curved slightly to better follow the contour of the user's arm.

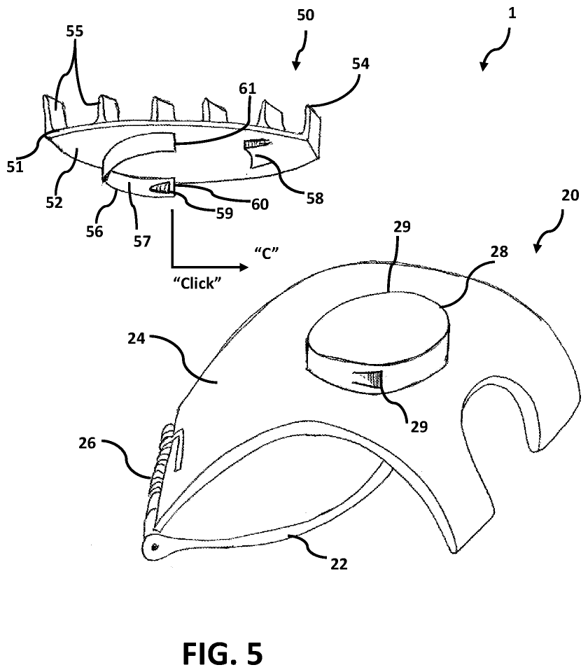

The underside of the instrument tray 50 includes a connection piece 56 in the form of a curved brim extending vertically downward from the underside 52 of the base 51. The brim 56 is curved to match the generally circular shape of the raised attachment piece 28 on the upper cuff 24. The brim 56 includes raised outdents 59 positioned on the inside surface 57 of the brim 56 near the two outer ends 60 and 61 of the brim 56. The raised outdents 59 are configured and position to fit into the indents 29 on the attachment piece 28 to provide a “click-fit” attachment between the instrument tray 50 and the upper cuff 24 when the brim 56 is slid in the direction “C” over the attachment piece 28 as illustrated in FIG. 5. A raised stop 58 extends downward from the underside of the inside surface 57 of the base 51. The stop 58 is located opposite the brim 56 and is positioned to hold the attachment piece 28 between the brim 56 and the stop 58 when the instrument tray 50 is “clicked” onto the upper cuff 24. The stop 58 is used to reduce the possibility of accidental detachment of the instrument tray 50 from the upper cuff 24.

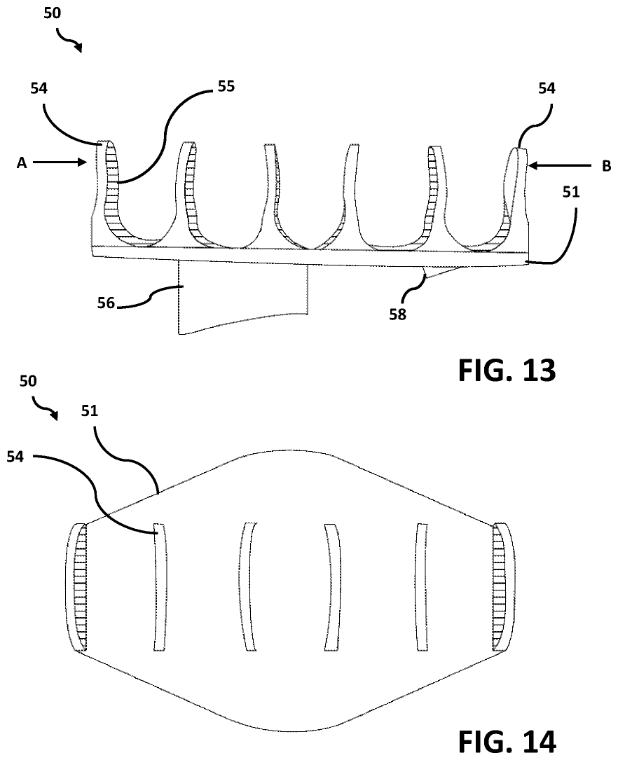

The instrument tray 50 is made from a flexible material such as plastic or a light-weight metal. By pinching the two end projections 54 of the tray 50 together in the directions A and B (see FIG. 13) the tray is caused to flex sufficiently to disengage the outdents 59 on the brim 56 from the indents 29 on the attachment piece 28 allowing removal of the tray 50 from the outer cuff 24 by moving it opposite direction “C” shown in FIG. 5. This is an important feature of the applicant's holder for dental instruments since is allows for the quick and easy removal of the tray 50 from the outer cuff 24 to permit cleaning of the tray and the instruments 100 and replacement with a new set of instruments 100 which can be loaded onto a different tray 50.

The holder for dental instruments 1 can be made from sterilizable and autoclavable medical grade plastics or light-weight metals so that the device may be easily cleaned and sterilized between uses. The dental instruments 100 are removed from the tray 50 during the sterilization process.

A method for using the holder for dental instruments 1 will now be described. The main body 20 is opened by spreading the lower cuff 22 apart from the upper cuff 24 by overcoming the force of spring hinge 26. The main body 20 is placed around the forearm or wrist of the user and the lower cuff 22 and upper cuff 24 are allowed to close around the forearm or wrist under the force of the spring hinge 26 to secure the main body 20 in place around the user's arm. The instrument tray 50 is then removably secured in place on the upper cuff 24 by sliding the brim 56 onto the attachment piece 28 in the direction “C” shown in FIG. 5 so that the outdents 59 on the brim 56 engage with the indents 29 on the attachment piece 28 providing a removable “click-fit” engagement of the tray 50 with the upper cuff 24. The attachment piece 28 fits between the brim 56 and the stop 58 on the underside 52 of the tray 50 to prevent accidental removal of the tray 50. Dental instruments 100 may then be easily attached, removed and re-attached to their locations between the finger-like projections 54 and 54a on the tray 50 with minimal reaching and twisting or turning by the dental hygienist. In one embodiment, the dental instruments 100 may be pre-loaded onto the tray 50 before attachment to the main body 20.

To remove the tray 50 the outer most finger-like projections 54 are pinched together in directions A and B shown in FIG. 13. This causes the brim 56 to flex open sufficient to disengage the outdents 59 on the brim 56 from the indents 29 on the attachment piece 28 allowing removal of the tray 50 from the outer cuff 24 by sliding in a direction opposite direction “C” shown in FIG. 5.

The applicant's holder for dental instruments disclosed herein is advantageously more efficient and ergonomic when compared to the prior art, such as dental trays on portable carts or swing arms. Three or four of the most commonly used dental instruments may be loaded onto the removably attachable instrument tray 50 allowing the dental hygienist to clean every tooth in a majority of patient's mouths before having to turn or reach to retrieve a new instrument. The result is a saving of time and reduction of repetitive stress injuries to the hygienist. Dental hygienists are allotted only a specific amount of time per patient. By not having to reach for instruments the hygienist has more time for debridement, thereby providing the patient with a better outcome.

The embodiments described herein are intended to be illustrative of the present holder for dental instruments and are not intended to limit the scope of the holder for dental instruments. Various modifications and changes consistent with the description as a whole and which are readily apparent to the person of skill in the art are intended to be included. The appended claims should not be limited by the specific embodiments set forth in the examples but should be given the broadest interpretation consistent with the description as a whole.

1. A holder for a dental instrument tray, the holder comprising:
a main body removably attachable to a user's forearm, and
an attachment piece affixed to the main body for removable attachment of the instrument tray.

2. The holder of claim 1, wherein the main body comprises a lower cuff and an upper cuff.

3. The holder of claim 2, wherein the lower cuff and the upper cuff are hingably attached with a spring hinge, wherein the spring hinge creates a force sufficient to bias the lower cuff and the upper cuff together around the user's forearm.

4. The holder of claim 1, wherein the attachment tray comprises a connection piece for removable attachment to the attachment piece on the main body.

5. The holder of claim 4, wherein the attachment piece comprises a pair of indents, the indents being configured and positioned to engage with a pair of outdents on the connection piece such that when the outdents are engaged with the indents, the dental instrument tray is removably attached to the main body by a click fit.

6. The holder of claim 5, wherein the connection piece comprises a curved brim on an underside of the tray, the outdents being located on opposing ends of an inside surface of the curved brim.

7. The holder of claim 6, wherein the attachment piece is curved to match the curvature of the brim such that when inside surface of the brim is engaged horizontally with the attachment piece the outdents on the brim engage with the indents on the attachment piece.

8. The holder of claim 6, wherein the dental instrument tray comprises a stop protruding from the underside of the tray, the stop positioned opposite the brim and located to allow the attachment piece to fit between the brim and the stop to prevent accidental disengagement of the outdents and the indents when the tray is attached to the main body.

9. The holder of claim 1, wherein the dental instrument tray comprises multiple spaced-apart finger-like projections extending vertically upward from a topside of the tray for holding dental instruments.

10. The holder of claim 9, wherein the dental instruments are held removably in place between adjacent ones of the finger-like projections by a press fit connection.

11. A holder for dental instruments, the holder comprising:
a main body removably attachable to a user's forearm, the main body including an attachment piece;
a tray for holding the dental instruments, the try including a connecting piece for removable attachment to the attachment piece.

12. The holder of claim 11, wherein the attachment piece comprises a pair of indents, and the connecting piece comprises a curved brim located on an underside of the tray, wherein the indents are sized and positioned to be engageable with a pair of outdents located on opposing ends of an inside surface of the curved brim.

13. The holder of claim 12, wherein the attachment piece is curved to match the curvature of the brim such that when the inside surface of the brim is engaged horizontally with the attachment piece the outdents on the brim engage with the indents on the attachment piece to provide a removable click fit attachment of the tray to the main body.

14. The holder of claim 12, wherein the dental instrument tray comprises a stop protruding from the underside of the tray, the stop positioned opposite the brim and located to allow the attachment piece to fit between the brim and the stop to prevent accidental disengagement of the outdents and the indents when the tray is removably attached to the main body.

15. The holder of claim 11, wherein the dental instrument tray comprises multiple spaced-apart finger-like projections extending vertically upward from a topside of the tray for holding the dental instruments.

16. The holder of claim 15, wherein the dental instruments are held removably in place between adjacent ones of the finger-like projections by a press fit connection.

17. The holder of claim 11, wherein the main body comprises a lower cuff and an upper cuff.

18. The holder of claim 17, wherein the lower cuff and the upper cuff are hingably attached with a spring hinge, wherein the spring hinge creates a force sufficient to bias the lower cuff and the upper cuff together around the user's forearm.

19. A method comprising:
providing a holder for dental instruments, the holder comprising a main body, the main body comprising a lower cuff hingably connected with a spring hinge to an upper cuff, the upper cuff including an attachment piece;
opening the spring hinge;
positioning the main body around a user's forearm;
allowing the spring hinge to close thereby removably attaching the main body around the forearm of the user;
providing a dental instrument tray with a connecting piece located on an underside of the tray and multiple finger-like projections extending vertically upward from a topside of the tray;
removably attaching the instrument tray to the main body by engaging the connecting piece on the tray with the attachment piece on the main body; and
removably attaching the dental instruments to the tray between adjacent ones of the finger-like projections by a press fit.
